(19) United States
(12) Patent Application Publication
(10) Pub. No.: US 2007/0088811 A1
(43) Pub. Date: Apr. 19, 2007

(54) MANAGEMENT SYSTEM AND METHOD OF STORING COMPONENTS IN A DISTRIBUTED SYSTEM

(76) Inventors: Hoi Chan, Shenzhen (CN); Gang Liu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,337

(22) Filed: Jul. 27, 2006

(30) Foreign Application Priority Data
Aug. 16, 2005 (CN) 200510036727.6

(51) Int. Cl. G06F 15/173

(52) U.S. Cl. 709/223

(57) ABSTRACT

An exemplary management system of storing components in a distributed system is disclosed. The management system includes a host node server (40) and at least one minor node server (10), and each minor node server is connected with the host node server via a network (30). Each minor node server is configured for dividing synchronization contents in the distributed system into various initial components according to an attribute-similar principle, and for sending various requests for synchronizing information of the components to the host node server. The host node server is configured for synchronizing corresponding components according to the received requests, providing an attribute list and a location list for describing instinct attributes and locations of each component respectively, and for copying the attribute list and the location list to each minor node server after a predetermined period of time. A related method is also disclosed.

### FIELD OF THE INVENTION

The present invention relates to management systems and methods of storing components, and more particularly to a management system and method of storing components in a distributed system.

### DESCRIPTION OF RELATED ART

There are many challenges to overcome in successfully designing different types of distributed systems. The main goal of a distributed system is to connect users and resources in a transparent, open, and scalable way. Ideally this arrangement is drastically more fault tolerant and more powerful than many other combinations of stand-alone systems. An example of a distributed system is the World Wide Web. As you are reading a Web page, you are actually using the distributed system that comprises the Web site. As you are browsing the Web, your Web browser running on your own computer communicates with different Web servers that provide Web pages. Possibly, your browser uses a proxy server to access the Web contents stored on Web servers fast and securely. To find these servers, it also uses a distributed domain name system. Your Web browser communicates with all of these Web servers over the Internet, via a system of routers that are themselves part of a large distributed system.

Generally, in present distributed systems, synchronization contents are not divided by availability and reasonability, therefore, the distributed systems can only synchronize a whole directory structure from a host node to each minor node in the distributed systems. This implies a main performance disadvantage that each minor node would contain completely identical contents with the host node even though particular contents are possibly unwanted in the minor nodes. Therefore, this kind of synchronization manner is not satisfied and not widely used in the distributed systems.

What is needed, therefore, is a management system and method of storing components in a distributed system, which can synchronously manage component information between a host node and a plurality of minor nodes in a distributed system according to users' requirements, so as to effectively economize storage space of each node server.

### SUMMARY OF INVENTION

One embodiment provides a management system of storing components in a distributed system. The management system includes a host node server and at least one minor node server. Each minor node server is connected with the host node server via a network. Each minor node server is configured for dividing synchronization contents in the distributed system into various initial components according to an attribute-similar principle, and for sending various requests for synchronizing information of the components to the host node server. The host node server is configured for synchronizing corresponding components to actualize the storing management of the components according to the received requests, providing an attribute list and a location list for describing instinct attributes and locations of each component respectively, and for copying the attribute list and the location list to each minor node server after a predetermined period of time.

Another embodiment provides a management method of storing components in a distributed system. The method includes the steps of: (a) providing an attribute list for describing instinct attributes of each component and a location list for describing locations of each component in a host node server; (b) copying the attribute list and the location list of the host node server into each minor node server after a predetermined period of time; (c) dividing synchronization contents in the distributed system into various initial components in the minor node server according to an attribute-similar principle; (d) providing a request queue in the host node server for receiving synchronization requests sent by the minor node server; (e) checking whether there is a new synchronization request in the request queue of the host node server; (f) checking the type of the new synchronization request by performing an automatic scan, if a new synchronization request is in the request queue of the host node server; (g) uploading the initial components from the minor node server to the host node server, updating attribute data of the components in the attribute list, and updating location information of the components in the location list, if the new synchronization request is an uploading request; (h) downloading components from the host node server, and updating location information of the downloaded components in the location list, if the new synchronization request is a downloading request; and (i) deleting components from the minor node server, and updating location information of the deleted components in both the location list in the host node server and a copied location list in the minor node server, if the new synchronization request is a deleting request.

Other objects, advantages and novel features of the embodiments will be drawn from the following detailed description together with the attached drawings, in which:

### BRIEF DESCRIPTION OF DRAWINGS

FIG. 1 is a schematic diagram of a hardware configuration and application environment of a management system of storing components in a distributed system in accordance with a preferred embodiment;

FIG. 2 is a schematic diagram illustrating an attribute list in the host node server of FIG. 1;

FIG. 3 is a schematic diagram illustrating a location list in the host node server of FIG. 1; and

FIG. 4 is a flow chart of a preferred management method of storing components in a distributed system by utilizing the management system of FIG. 1.

### DETAILED DESCRIPTION

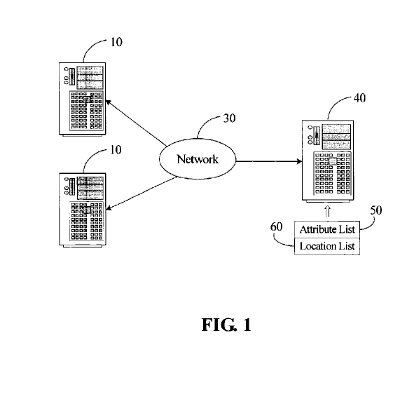

FIG. 1 is a schematic diagram of a hardware configuration and application environment of a management system of storing components in a distributed system in accordance with a preferred embodiment. The management system includes a host node server 40 and at least one minor node server 10. Each minor node server 10 is connected with the host node server 40 via a network 30. In the preferred embodiment, only two minor node servers 10 are shown in FIG. 1 as an illustrative instance. The network 30 can be an intranet, the Internet, or any other suitable type of communication network.

Each minor node server 10 is configured for dividing synchronization contents in the distributed system into various virtual initial components according to an attribute-similar principle, these components are regarded as fundamental units of synchronization and management of the contents in the distributed system. In addition, each minor node server 10 is also used for sending various synchronization requests to the host node server 40 via the network 30 in order to manage storing of the components in both the host node server 40 and each minor node server 10. The host node server 40 can store the synchronization requests received in a request queue. The synchronization requests may be uploading requests for uploading the initial components to the host node server 40, or downloading requests for downloading components from the host node server 40 to the minor node server 10, or deleting requests for deleting components in the minor node server 10.

The host node server 40 is configured for synchronizing corresponding components to actualize the storing management of the components according to the received requests and for providing an attribute list 50 for describing intrinsic attributes of each component and a location list 60 for describing location information of each component. Herein, locations of each component may only exist in the host node server 40, or only in the minor node server 10, or in both the host node server 40 and the minor node server 10.

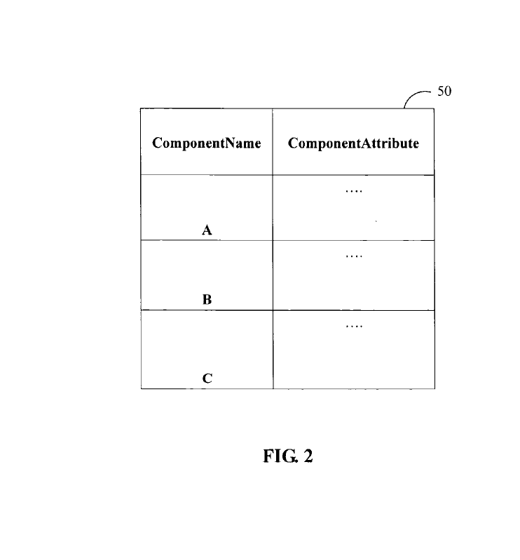

FIG. 2 is a schematic diagram illustrating the attribute list 50 in the host node server 40. The attribute list 50 contains two columns, a column (symbolically depicted as “ComponentName” column) is for storing a name of each component, and a column (symbolically depicted as “ComponentAttribute” column) is for storing attribute data of each component. For example, if the component is an application program named “A,” the name “A” is stored in the “ComponentName” column, and the attribute data related to the application program is stored in the corresponding “ComponentAttribute” column that may include version, language, or an operating environment of the application program.

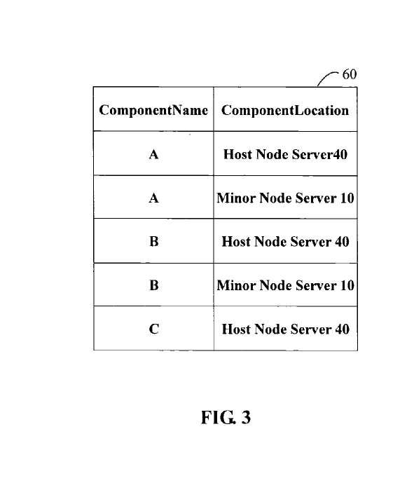

FIG. 3 is a schematic diagram illustrating the location list 60 in the host node server 40. The location list 60 contains two columns, a column (symbolically depicted as “ComponentName” column) is for storing a name of each component, and a column (symbolically depicted as “ComponentLocation” column) is for storing location information of each component in both the host node server 40 and the minor node server 10. I.e., if a component named “A” exists in the host node server 40, it also exists in the minor node server 10. For each component, there may exist a plurality of records describing its corresponding location information in the location list 60. Moreover, the attribute list 50 and the location list 60 in the host node server 40 are to be copied into each minor node server 10 after a predetermined period of time, such as every 10 seconds. Therefore, a copy of the attribute list 50 and a copy of the location list 60 are generated in each minor node server 10.

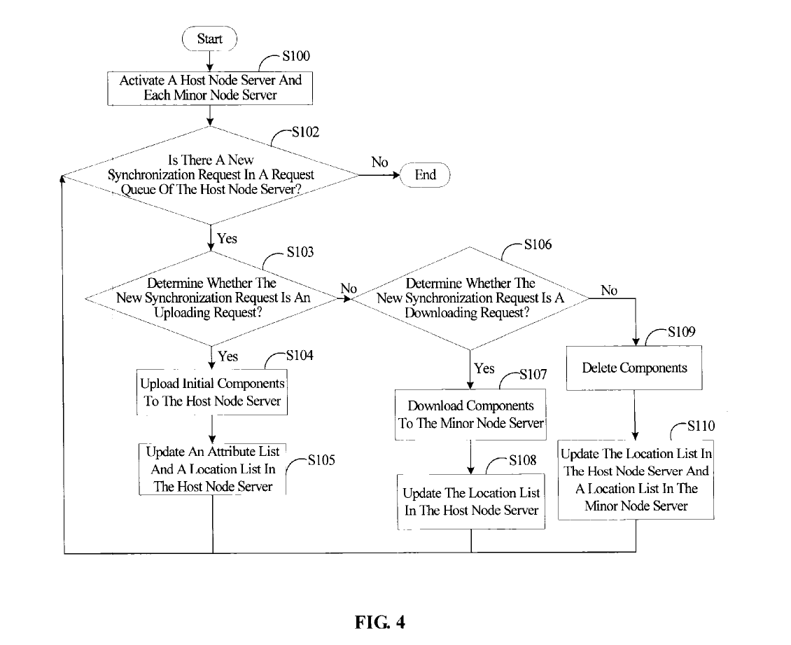

FIG. 4 is a flow chart of a preferred management method of storing components in a distributed system by utilizing the management system. In step S100, the host node server 40 and the minor node server 10 are activated. In step S102, the host node server 40 performs a first automatic scan to determine whether there are any new synchronization requests in the request queue of the host node server 40. The synchronization request may be the uploading request for uploading the initial components to the host node server 40, the downloading request for downloading components from the host node server 40 to the minor node server 10, or the deleting request for deleting components in the minor node server 10. If there are not any new synchronization requests, the procedure ends.

Otherwise, if the new synchronization request is in the request queue, in step S103, the host node server 40 performs a second automatic scan to determine whether the new synchronization request is the uploading request from the minor node server 10. If the new synchronization request is the uploading request, in step S105, the minor node server 10 uploads the initial components to the host node server 40. In step S105, the host node server 40 updates attribute data and location information of the initial components in the attribute list 50 and the location list 60 respectively, and the procedure returns to step S102 described above.

If the new synchronization request is not an uploading request, in step S106, the host node server 40 performs a third automatic scan to determine whether the new synchronization request is the downloading request. If the new synchronization request is the downloading request, in step S107, the host node server 40 downloads the components to the minor node server 10. In step S108, the host node server 40 updates location information of the downloaded components in the location list 60 of the host node server 40, and then the procedure returns to step S102. If the new synchronization request is not the downloading request, then, the new request is the deleting request. In step S109, the host node server 40 deletes components in the minor node server 10 according to the deleting request. In step S110, the host node server 40 updates location information of the deleted components in both the location list 60 of the host node server 40 and the copy of the location list 60 in the minor node server 10, then the procedure returns to step S102.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A management system of storing components in a distributed system, the management system comprising:
a host node server and at least one minor node server, the host node server connected with each minor node server via a network, wherein:
each minor node server is configured for dividing synchronization contents in the distributed system into various initial components according to an attribute-similar principle, and for sending various requests for synchronizing information of the components to the host node server; and
the host node server is configured for synchronizing information of the components to actualize the storing management of the components according to the received requests, providing an attribute list and a location list for describing instinct attributes and locations of each component respectively, and for copying the attribute list and the location list to each minor node server after a predetermined period of time.

2. The system according to claim 1, wherein the requests comprise uploading requests for uploading the initial components from the minor node server to the host node server, and updating the attribute list and the location list in the host node server after uploading the initial components.

3. The system according to claim 1, wherein the requests comprise downloading requests for downloading components from the host node server to the minor node server, and for updating the location list in the host node server after downloading the components.

4. The system according to claim 1, wherein the synchronization requests comprise deleting requests for deleting components from the minor node server, and for updating the location list in the host node server and a copied location list in the minor node server after deleting the components.

5. A management method of storing components in a distributed system, the method comprising the steps of:
providing an attribute list for describing instinct attributes of each component and a location list for
describing locations of each component in a host node server;
copying the attribute list and the location list of the host node server into each minor node server after a predetermined period of time;
dividing synchronization contents in the distributed system into various initial components in the minor node server according to an attribute-similar principle;
providing a request queue in the host node server for receiving synchronization requests sent by the minor node server;
checking whether there is a new synchronization request in the request queue of the host node server;
checking the type of the new synchronization request by performing an automatic scan, if the new synchronization request is in the request queue of the host node server;
uploading the initial components from the minor node server to the host node server, updating attribute data of the components in the attribute list, and updating location information of the components in the location list, if the new synchronization request is an uploading request;
downloading components from the host node server, and updating location information of the downloaded components in the location list, if the new synchronization request is a downloading request; and
deleting components from the minor node server, and updating location information of the deleted components in both the location list in the host node server and a copied location list in the minor node server, if the new synchronization request is a deleting request.

6. The method according to claim 5, wherein the step of checking whether there is a new synchronization request in the request queue of the host node server further comprising:
ending the procedure, if the new synchronization request is not in the request queue of the host node server.

7. The method according to claim 5, wherein the synchronization requests comprise uploading requests, downloading requests, and deleting requests.

8. A management method of storing components in a distributed system, the method comprising the steps of:
providing an attribute list for describing instinct attributes of each component and a location list for describing locations of each component in a host node server;
generating a copied attribute list in each minor node server by copying the attribute list from the host node server after a predetermined period of time;
generating a copied location list in each minor node server by copying the location list from the host node server after a predetermined period of time;
dividing synchronization contents in the distributed system into various initial components in the minor node server according to an attribute-similar principle;
sending a synchronization request from the minor node server to the host node server;
checking the type of the synchronization request by performing an automatic scan; and
synchronously managing information of the components in both the host node server and the minor node server according to the synchronization request.

9. The method according to claim 8, wherein the synchronization request may be an uploading requests, a downloading request, or a deleting request.

10. The method according to claim 8, wherein the step of synchronously managing information of the components further comprises the step of:
uploading the initial components from the minor node server to the host node server, and updating attribute data of the components in the attribute list, and location information of the components in the location list, if the synchronization request is an uploading request.

11. The method according to claim 8, wherein the step of synchronously managing information of the components further comprises the step of:
downloading components from the host node server to the minor node server, and updating location information of the downloaded components in the location list, if the synchronization request is a downloading request.

12. The method according to claim 8, wherein the step of synchronously managing information of the components further comprises the step of:
deleting components from the minor node server, and updating location information of the deleted components in both the location list in the host node server and the copied location list in the minor node server, if the synchronization request is a deleting request.
